(19) United States
(12) Patent Application Publication
(10) Pub. No.: US 2002/0029247 A1
(43) Pub. Date: Mar. 7, 2002

(54) Electronic-mail transmission/reception apparatus hierarchizing and displaying electronic mails based on specified condition

(76) Inventor: Mikio Kawamoto, Toyama (JP)

Correspondence Address: STAAS & HALSEY LLP, 700 11TH STREET, NW, SUITE 500, WASHINGTON, DC, 20001, US

(21) Appl. No.: 09/788,473

(22) Filed: Feb. 21, 2001

(30) Foreign Application Priority Data
Sep. 4, 2000 (JP) 2000-267360

(51) Int. Cl. G06F 15/16

(52) U.S. Cl. 709/206; 709/236

(57) ABSTRACT

An electronic-mail transmission/reception apparatus transmits and receives electronic mails. In the electronic-mail transmission/reception apparatus: a condition setting unit sets in the electronic-mail transmission/reception apparatus a condition for displaying a list of at least one information item on at least one title of at least one electronic mail which has been transmitted or received; a sorting unit sorts the at least one information item into a hierarchical structure according to the condition; and a list displaying unit displays a list of the at least one information item which is sorted by the sorting unit.

### BACKGROUND OF THE INVENTION

1) Field of the Invention

The present invention relates to an electronic-mail transmission/reception apparatus which exchanges electronic mails with other parties.

2) Description of the Related Art

With the wide spread use of the Internet, exchange of information by using electronic mails or the like is increasing. In the conventional electronic-mail transmission/reception apparatuses, received electronic mails are stored in a received-electronic-mail box, and transmitted electronic mails are stored in a transmitted-electronic-mail box. The electronic-mail transmission/reception apparatuses display a list of the received electronic mails or the transmitted electronic mails in response to a request from a user.

When a reply to a received electronic mail has already been sent, or when a received electronic mail has already been forwarded, some recent electronic-mail transmission/reception apparatuses display with a title (or subject) of the received electronic mail a predetermined symbol indicating that a reply to the received electronic mail has already been sent, or the received electronic mail has already been forwarded. In addition, some other electronic-mail transmission/reception apparatuses display a subordinate relation between an original electronic mail and a replied or forwarded electronic mail in the form of a hierarchical structure.

In practice, often, electronic mails are repeatedly exchanged between specific parties. However, the conventional electronic-mail transmission/reception apparatuses cannot display the electronic mails repeatedly exchanged between specific parties, together with relationships between the electronic mails.

Further, an electronic mail can be easily transmitted to a party when the electronic mail is transmitted as a reply to another electronic mail received from the party. Therefore, an electronic mail is often transmitted as a reply to another electronic mail even when the subjects of these electronic mails are different. Thus, it is difficult to determine an actual relationship between electronic mails, based on whether or not one of the electronic mails is a reply to the other.

### SUMMARY OF THE INVENTION

The object of the present invention is to provide an electronic-mail transmission/reception apparatus which can display received or transmitted electronic mails so that users can easily recognize the received or transmitted electronic mails.

According to the first aspect of the present invention, there is provided an electronic-mail transmission/reception apparatus for transmitting and receiving electronic mails, comprising: a condition setting unit which sets in said electronic-mail transmission/reception apparatus a condition for displaying a list of at least one information item on at least one title of at least one electronic mail which has been transmitted or received; a sorting unit which sorts the at least one information item into a hierarchical structure according to the condition; and a list displaying unit which displays a list of the at least one information item which is sorted by the sorting unit.

The electronic-mail transmission/reception apparatus according to the first aspect of the present invention may also have one or any possible combination of the following additional features (i) to (iii).

(i) The sorting unit may sort the at least one information item according to attribute information which each of the at least one electronic mail has.

(ii) The attribute information may be contained in a header of the at least one electronic mail.

(iii) The electronic-mail transmission/reception apparatus according to the first aspect of the present invention may further comprise a display information removing unit which removes a portion of information displayed by the list displaying unit, according to display capacity of the list displaying unit.

According to the first aspect of the present invention, the condition for displaying the at least one electronic mail is set by a user in the electronic-mail transmission/reception apparatus, and the target electronic mail or mails are sorted according to the condition. Further, the sorted electronic mail or mails are displayed in the form of a hierarchical structure (e.g., a tree). Therefore, viewability can be increased. In other words, the transmitted or received electronic mails are displayed so that users can easily recognize the relationships between the transmitted or received electronic mails. Thus, the user can easily perform operations relating to electronic mails, based on the relationships between the transmitted or received electronic mails.

According to the second aspect of the present invention, there is provided a computer-readable storage medium storing a program which makes a computer execute processing for transmitting and receiving electronic mails. The program further makes the computer realize: a condition setting unit which sets in the computer a condition for displaying a list of at least one information item on at least one title of at least one electronic mail which has been transmitted or received; a sorting unit which sorts the at least one information item into a hierarchical structure according to the condition; and a list displaying unit which displays a list of the at least one information item which is sorted by the sorting unit.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram illustrating the basic principle of the electronic-mail transmission/reception apparatus according to the present invention;

FIG. 2 is a diagram illustrating an example of a configuration of a communication system in which the electronic-mail transmission/reception apparatus according to the present invention is used;

FIG. 3 is a diagram illustrating an example of a hardware construction of the electronic-mail transmission/reception apparatus according to the present invention;

FIG. 4 is a diagram illustrating an example of a window which is displayed when electronic-mail transmission/reception software is started;

FIG. 5 is a diagram illustrating an example of a window which is displayed when the first display setting button is manipulated in the window of FIG. 4;

FIG. 6 is a diagram illustrating an example of a window which is displayed when the second display setting button is manipulated in the window of FIG. 4;

FIG. 7 is a diagram illustrating an example of a sequence of electronic mail exchange between two parties;

FIG. 8 is a diagram illustrating an example of a tree representing relationships between electronic mails;

FIG. 9 is a diagram illustrating the electronic mail “02” as an example;

FIG. 10 is a diagram illustrating the electronic mail “04” as an example;

FIG. 11 is a diagram illustrating the electronic mail “05” as an example;

FIG. 12 is a diagram illustrating an example of a window which is displayed when setting operations in the windows of FIGS. 5 and 6 are completed;

FIG. 13 is a diagram illustrating an example of a display of trees and information on electronic mails which are grouped according to sender information;

FIG. 14 is a diagram illustrating an example of a display of trees and information on electronic mails which are grouped according to types of electronic mails;

FIG. 15 is a flow diagram illustrating an example of a sequence of operations performed in the electronic-mail transmission/reception apparatus as an embodiment of the present invention;

FIG. 16 is a flow diagram illustrating an example of a sequence of operations of producing a tree in step S7 of FIG. 15;

FIG. 17(A) is a diagram illustrating an example of trees and information on electronic mails which are to be displayed; and

FIG. 17(B) is a diagram illustrating an example of a restricted display on a small display screen, of the trees and the information in FIG. 17(A).

### DESCRIPTION OF THE PREFERRED EMBODIMENTS

### (1) Basic Construction

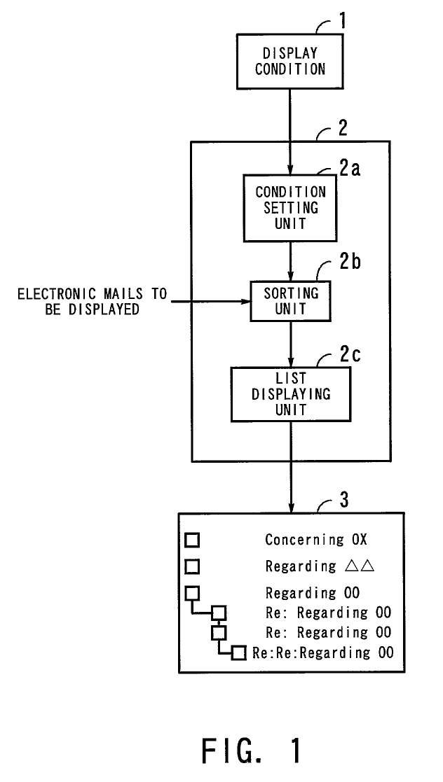

FIG. 1 is a diagram illustrating the principle of the electronic-mail transmission/reception apparatus according to the present invention. The electronic-mail transmission/reception apparatus 2 in FIG. 1 comprises a condition setting unit 2a, a sorting unit 2b, and a list displaying unit 2c. The condition setting unit 2a sets a condition for displaying a list of at least one information item on at least one title of at least one electronic mail which has been transmitted or received, the sorting unit 2b sorts the at least one information item into a hierarchical structure according to the condition, and the list displaying unit 2c displays a list of the at least one information item which is sorted by the sorting unit.

The operations of the electronic-mail transmission/reception apparatus according to the present invention are explained below.

When a user wishes to display a list of electronic mails transmitted or received by the electronic-mail transmission/reception apparatus 2, first, the user inputs a display condition 1 into the electronic-mail transmission/reception apparatus 2. The display condition 1 is a condition which is used as a reference in extracting a group of electronic mails between which a specific relationship exists, from electronic mails to be displayed. An example of the display condition 1 is a condition that the character strings included in the titles (subjects) of the electronic mails are nearly identical, where the titles of the electronic mails are usually indicated as the “subjects”. The hierarchizing (sorting) operation is performed on the electronic mails in each group extracted as above.

The condition setting unit 2a acquires the display condition 1, and supplies the display condition 1 to the sorting unit 2b. In this case, it is assumed that the display condition 1 requires that the character strings included in the titles of the electronic mails are nearly identical. For example, the display condition 1 requires that the character strings included in the titles of the respective electronic mails are identical except for the character string “Re:”

The sorting unit 2b refers to the display condition 1, and sorts the electronic mails to be displayed, in accordance with a predetermined rule. In this case, the sorting unit 2b sorts electronic mails having nearly identical character strings in their titles into a group. Then, the sorting unit 2b obtains a tree structure for each group based on subordinate relations between electronic mails in each group. For example, the subordinate relations are each a relationship between an original electronic mail and a replied electronic mail.

Next, the list displaying unit 2c displays the electronic mails in each group and the tree structure obtained as above, for example, as illustrated by the reference number 3 in FIG. 1. In the display example 3 in FIG. 1, three trees (corresponding to three groups) and six electronic mails respectively having the titles “Concerning OX”, “Regarding ΔΔ”, “Regarding OO”, “Re: Regarding OO”, “Re: Regarding OO”, and “Re: Re: Regarding OO”are indicated. The electronic mails having the titles “Concerning OX” and “Regarding ΔΔ” are respectively sorted into the first and second groups, each of which includes only one electronic mail. The remaining four electronic mails having the titles “Regarding OO”, “Re: Regarding OO”, “Re: Regarding OO”, and “Re: Re: Regarding OO” are sorted into the third group. Therefore, the titles “Concerning OX” and “Regarding ΔΔ” are indicated corresponding to the first and second tree structures, respectively. The remaining four electronic mails respectively having the titles “Regarding OO”, “Re: Regarding OO”, “Re: Regarding OO”, and “Re: Re: Regarding OO” are indicated corresponding to the third tree structure, which corresponds to the subordinate relations between the four electronic mails.

As described above, according to the present invention, the titles of the electronic mails to be displayed are sorted according to the display condition 1, and the sorted result is displayed. Therefore, the electronic mails can be grouped depending on the objective, and displayed together with corresponding tree structure as necessary. That is, the electronic mails can be displayed in a manner in which an actual sequence of electronic mail exchange is reflected.

### (2) Configuration of Communication System

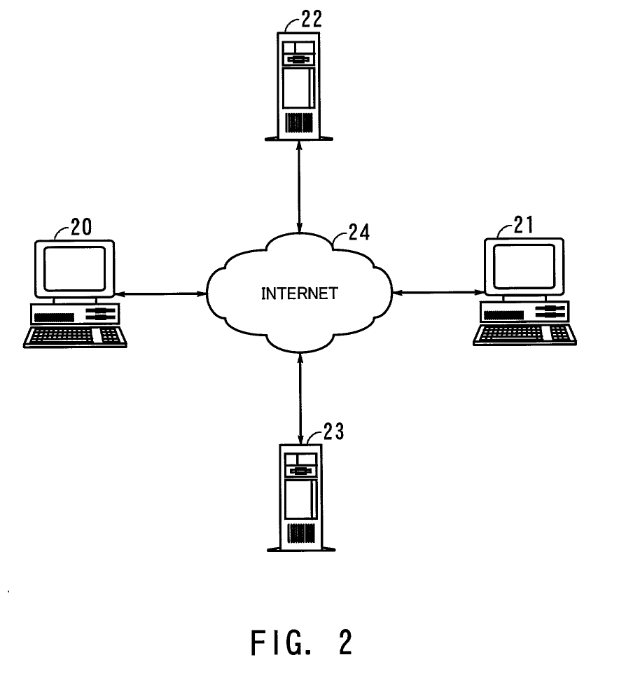

FIG. 2 is a diagram illustrating an example of a configuration of a communication system in which the electronic-mail transmission/reception apparatus according to the present invention is used. In FIG. 2, the electronic-mail transmission/reception apparatuses 20 and 21 are connected to each other through the Internet 24. In addition, an SMTP (Simple Mail Transfer Protocol) server 22 and a POP (Post Office Protocol) server 23 are connected to the Internet 24.

The SMTP server 22 receives electronic mails from the electronic-mail transmission/reception apparatuses 20 and 21, and sends the electronic mails through a predetermined path to a server which accommodates a destination (electronic-mail transmission/reception apparatus). The POP server 23 sorts the electronic mails transmitted from the SMTP server 22, by destination users, and stores the sorted electronic mails. When a user accesses the POP server 23, the POP server 23 sends to the user an electronic mail which is addressed to the user.

The Internet interconnects the electronic-mail transmission/reception apparatuses 20 and 21, the SMTP server 22, and the POP server 23, and enables exchange of information between the electronic-mail transmission/reception apparatuses 20 and 21, the SMTP server 22, and the POP server 23.

### (3) Configuration of Communication System

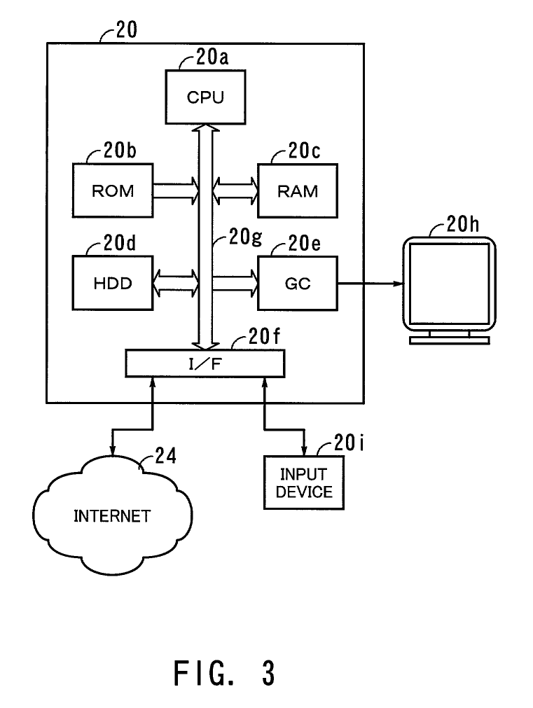

FIG. 3 is a diagram illustrating an example of a hardware construction of the electronic-mail transmission/reception apparatus 20 according to the present invention. The electronic-mail transmission/reception apparatus 20 illustrated in FIG. 3 comprises a CPU (Central Processing Unit) 20a, a ROM (Read-Only Memory) 20b, a RAM (Random Access Memory) 20c, an HDD (Hard Disk Drive) 20d, a GC (Graphic Card) 20e, an (I/F) interface 20f, and a bus 20g. In addition, a display device 20h and an input device 20i are externally connected to the electronic-mail transmission/reception apparatus 20. The CPU 20a controls the respective portions of the electronic-mail transmission/reception apparatus 20, and performs various operations in accordance with programs. The ROM 20b stores basic programs which are executed by the CPU 20a, data, and the like. The RAM 20c stores programs currently executed by the CPU 20a, and data which are currently processed. The HDD 20d stores programs executed by the CPU 20a and electronic mails which have been received and transmitted. The GC 20e executes graphics-drawing processing in response to a graphics-drawing instruction or the like which is supplied from the CPU 20a. The GC 20e transforms an image, which is obtained by the graphics-drawing processing, into an image signal, and supplies the image signal to the display device 20h. The interface 20fe converts protocols when data is exchanged between the electronic-mail transmission/reception apparatus 20 and the Internet 24, and also converts data forms when data is input from the input device 20i. The bus 20g interconnects the CPU 20a, the ROM 20b, the RAM 20c, the HDD 20d, the GC 20e, and the interface 20f, and enables exchange of information between the CPU 20a, the ROM 20b, the RAM 20c, the HDD 20d, the GC 20e. The display device 20h is realized by, for example, a CRT (cathode ray tube) monitor, and displays the image signal output from the GC 20e. The input device 20i is realized by, for example, a keyboard and/or a mouse, generates data according to manipulation by a user, and supplies the generated data to the electronic-mail transmission/reception apparatus 20.

### (4) Setting of Sorting Conditions

When a user manipulates the input device 20i so as to start software for transmission and reception of electronic mails, the software is read out from the HDD 20d, and loaded in the RAM 20c for execution, as necessary.

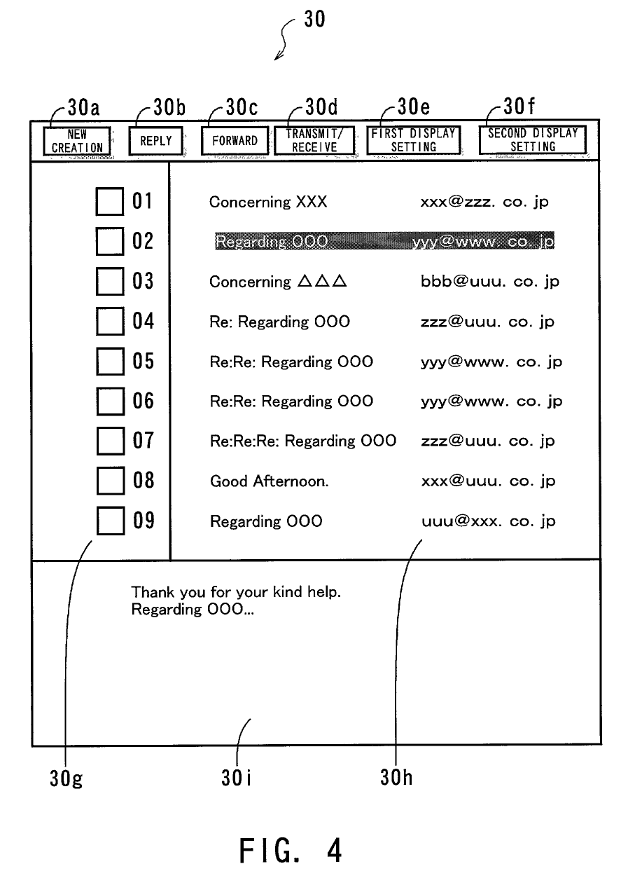

FIG. 4 is a diagram illustrating an example of a window which is displayed when the software for mail transmission/reception is started. In the example of FIG. 4, a “NEW CREATION” button 30a, a “REPLY” button 30b, a “FORWARD” button 30c, a “TRANSMIT/RECEIVE” button 30d, a “FIRST DISPLAY SETTING” button 30e, and a “SECOND DISPLAY SETTING” button 30f are indicated at the top portion of the window 30.

The “NEW CREATION” button 30a is manipulated when an electronic mail is newly created. The “REPLY” button 30b is manipulated when a reply to a received electronic mail is created. Namely, when the “REPLY” button 30b is manipulated, an electronic mail which is addressed to a sender of the received electronic mail can be created. The “FORWARD” button 30c is manipulated when a received electronic mail is forwarded to another party. The “TRANSMIT/RECEIVE” button 30d is manipulated when the electronic-mail transmission/reception apparatus 20 is connected to the POP server 23, and an electronic mail is transmitted or received. The “FIRST DISPLAY SETTING” button 30e is manipulated when electronic mails to be sorted is specified. The details of the operation of inputting information which specifies the electronic mails to be sorted are explained later. The “SECOND DISPLAY SETTING” button 30f is manipulated when a condition for determining a group or groups is input. The details of the operation of inputting the condition for producing a tree are also explained later.

In the display area 30g, squares indicated with serial numbers respectively correspond to electronic mails. In the display area 30h, titles (subject) and senders' mail addresses of the electronic mails are indicated corresponding to the serial numbers in the display area 30g. In the display area 30i, a text of one of the electronic mails which is designated (highlighted) in the display area 30h is indicated.

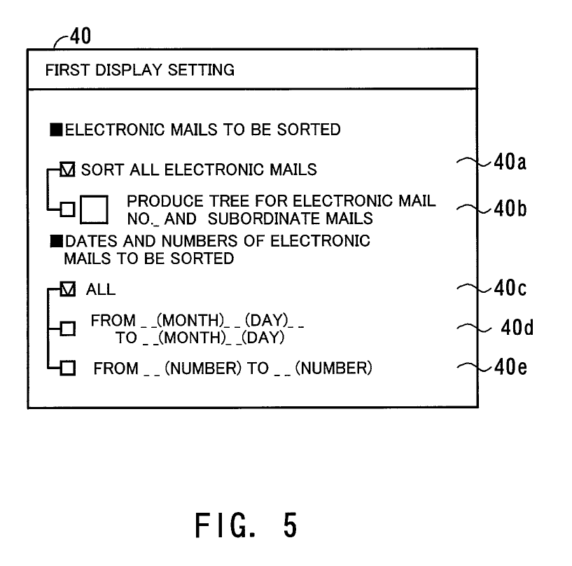

When the “FIRST DISPLAY SETTING” button 30e is manipulated in the window 30, the first display-setting window 40, as illustrated in FIG. 5, is displayed by the display device 20h. The first display-setting window 40 is displayed for specifying electronic mails which are to be sorted.

The user can specify select one of the setting items 40a and 40b. When the setting item 40a is selected, i.e., when the check box corresponding to the setting item 40a is checked, all of the electronic mails are sorted. When the setting item 40b is selected, i.e., the check box corresponding to the setting item 40b is checked, and one of the serial numbers indicated in the display area 30g is input into the text box in the setting item 40b, only electronic mails subordinate to the electronic mail corresponding to the one of the serial numbers input into the blank box in the setting item 40b are sorted.

In addition, the user can specify ranges of dates and serial numbers of electronic mails which are to be sorted, by selecting one of the setting items 40c, 40d, and 40e. When the setting item 40c is selected, i.e., when the check box corresponding to the setting item 40c is checked, the ranges of the dates and serial numbers of the electronic mails are not specified. That is, in this case, the electronic mails are sorted regardless of their dates and serial numbers. When the setting item 40d is selected, i.e., the check box corresponding to the setting item 40d is checked, and dates are input into the text boxes in the setting item 40d, only electronic mails which are transmitted or received within the period determined by the dates input into the text boxes in the setting item 40d are sorted. When the setting item 40e is selected, i.e., the check box corresponding to the setting item 40e is checked, and two of the serial numbers indicated in the display area 30g are input into the text boxes in the setting item 40e, only electronic mails in the range specified by the two of the serial numbers which are input into the text boxes in the setting item 40e are sorted.

When the setting items in the first display-setting window 40 are selected, i.e., the check boxes in the first display-setting window 40 are checked, and data are input into the text boxes as necessary, as explained above, the CPU 20a stores the setting information in a predetermined area of the HDD 20d.

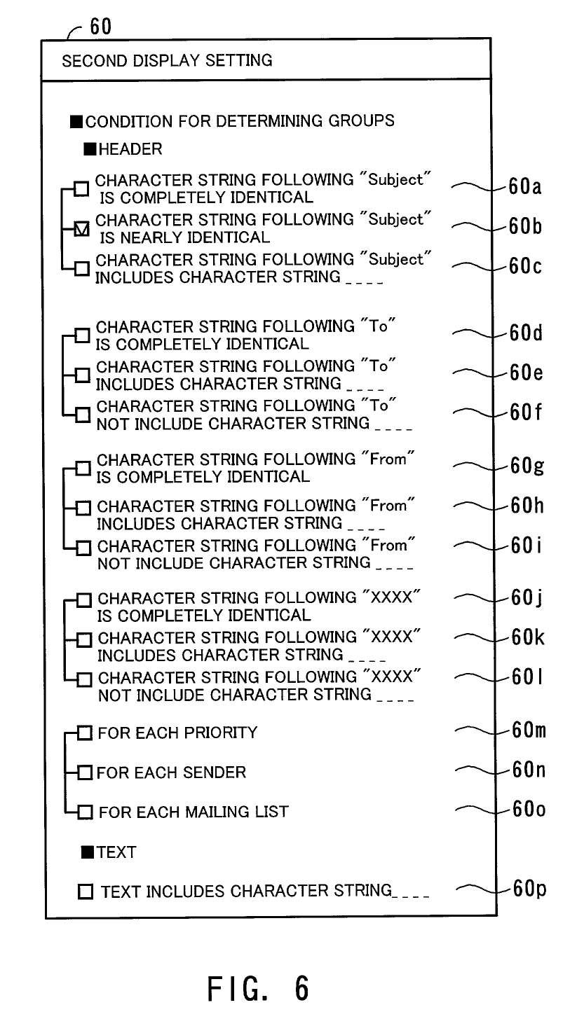

When the “SECOND DISPLAY SETTING” button 30f is manipulated in the window 30, the second display-setting window 60, as illustrated in FIG. 6, is displayed by the display device 20h. The second display-setting window 60 is displayed for setting a condition for determining a group or groups of electronic mails based on information included in headers or texts of the electronic mails.

The user can specify conditions for determining a group or groups of electronic mails based on information included in the headers of the electronic mails, by selecting one of the setting items 60a to 60o.

The user can specify a condition for determining a group or groups of electronic mails, based on the character strings of the titles (subjects) of the electronic mails, by selecting one of the setting items 60a to 60c. When the setting item 60a is selected, i.e., when the check box corresponding to the setting item 60a is checked, electronic mails having a completely identical title (subject) are sorted into a group forming a tree. When the setting item 60b is selected, i.e., when the check box corresponding to the setting item 60b is checked, electronic mails having a nearly identical title (subject) are sorted into a group forming a tree. For example, when 80% of character strings of titles of electronic mails coincide, or when character strings of titles of electronic mails coincide except for a specific character string such as “Re:”, the character strings may be determined to be nearly identical. When the setting item 60c is selected, i.e., the check box corresponding to the setting item 60c is checked, and a specific character string is input into a text box in the setting item 60c, electronic mails each having a title (subject) including the specific character string are sorted into a group forming a tree.

The user can specify a condition for determining a group or groups of electronic mails, based on character strings of destination (receiver) information in the electronic mails, by selecting one of the setting items 60d to 60f. Usually, the destinations (receivers) of electronic mails are indicated following “To” in the headers of the electronic mails. When the setting item 60d is selected, i.e., when the check box corresponding to the setting item 60d is checked, electronic mails having completely identical destination information are sorted into a group forming a tree. When the setting item 60e is selected, i.e., the check box corresponding to the setting item 60e is checked, and a specific character string is input into a text box in the setting item 60e, electronic mails each having destination information including the specific character string are sorted into a group forming a tree. When the setting item 60f is selected, i.e., the check box corresponding to the setting item 60f is checked, and a specific character string is input into a text box in the setting item 60f, electronic mails each having destination information which does not include the specific character string are sorted into a group forming a tree.

The user can specify a condition for determining a group or groups of electronic mails, based on character strings of sender information in the electronic mails, by selecting one of the setting items 60g to 60i. Usually, the senders of electronic mails are indicated following “From” in the headers of the electronic mails. When the setting item 60g is selected, i.e., when the check box corresponding to the setting item 60g is checked, electronic mails having completely identical sender information are sorted into a group forming a tree. When the setting item 60h is selected, i.e., the check box corresponding to the setting item 60h is checked, and a specific character string is input into a text box in the setting item 60h, electronic mails each having sender information including the specific character string are sorted into a group forming a tree. When the setting item 60i is selected, i.e., the check box corresponding to the setting item 60i is checked, and a specific character string is input into a text box in the setting item 60i, electronic mails each having sender information which does not include the specific character string are sorted into a group forming a tree.

The user can specify a condition for determining a group or groups of electronic mails, based on character strings in a predetermined information item (indicated as “XXXX” in FIG. 6) included in the headers of the electronic mails, by selecting one of the setting items 60j to 60l, where the predetermined information item is preset separately. When the setting item 60j is selected, i.e., when the check box corresponding to the setting item 60j is checked, electronic mails having the above predetermined information item represented by a completely identical character string are sorted into a group forming a tree. When the setting item 60k is selected, i.e., the check box corresponding to the setting item 60k is checked, and a specific character string is input into a text box in the setting item 60k, electronic mails in which the above predetermined information item includes the specific character string are sorted into a group forming a tree. When the setting item 60l is selected, i.e., the check box corresponding to the setting item 60l is checked, and a specific character string is input into a text box in the setting item 60l, electronic mails in which the above predetermined information item does not include the specific character string are sorted into a group forming a tree.

The user can specify a condition for determining a group or groups of electronic mails, based on specific information included in the headers of the electronic mails, by selecting one of the setting items 60m to 60o. When the setting item 60m is selected, i.e., when the check box corresponding to the setting item 60m is checked, electronic mails having an identical priority are sorted into a group forming a tree. When the setting item 60n is selected, i.e., when the check box corresponding to the setting item 60n is checked, electronic mails transmitted from an identical sender are sorted into a group forming a tree. When the setting item 60o is selected, i.e., when the check box corresponding to the setting item 60o is checked, electronic mails corresponding to each mailing list are sorted into a group forming a tree.

The user can specify a condition for determining a group or groups of electronic mails, based on character strings included in texts of the electronic mails, by selecting the setting item 60p. When the setting item 60p is selected, i.e., the check box corresponding to the setting item 60p is checked, and a specific character string is input into a text box in the setting item 60p, electronic mails which contains in their texts the specific character string are sorted into a group forming a tree.

In FIG. 6, only one setting item can be selected from each group of three setting items connected with solid lines. Therefore, when one of the three setting items is selected from each group, no other setting item in the group can be additionally selected. However, it is possible to select more than one setting item from different groups. For example, the setting items 60b and 60e can be selected concurrently.

When the setting items in the second display-setting window 60 are selected, i.e., the check boxes in the second display-setting window 60 are checked, and data are input into the text boxes as necessary, as explained above, the CPU 20a stores the information on the setting in a predetermined area of the HDD 20d.

When the sorting conditions are set as above, a sorting operation is performed on the electronic mails to be sorted, in accordance with the sorting conditions, and the result of the sorting operation is displayed in the display areas 30g and 30h in the window 30.

### (5) Example of Mail Exchange Sequence

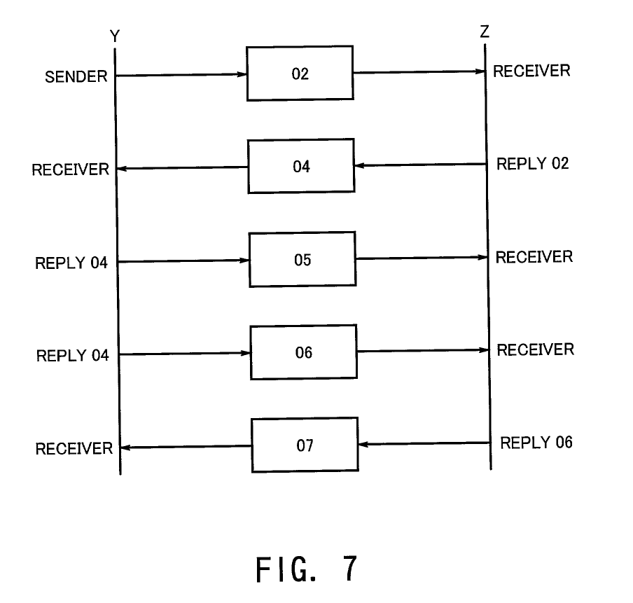

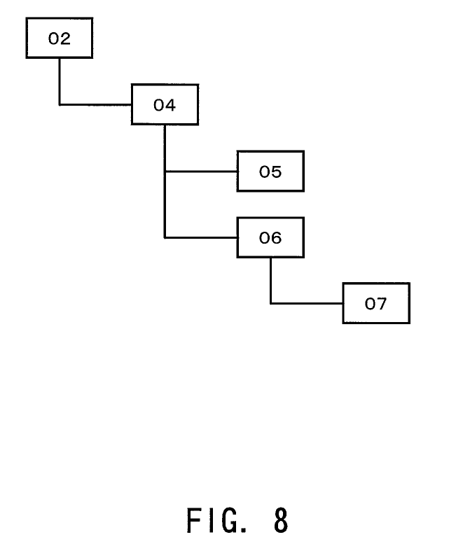

FIG. 7 is a diagram illustrating an example of a sequence of electronic mail exchange between two parties. The electronic mails 02, 04 to 07 displayed in the window 30 in FIG. 4 are exchanged between the two parties Y and Z, where the user Y is the user of the electronic-mail transmission/reception apparatus which is currently explained. FIG. 7 exhibits a sequence of exchange of the electronic mails 02, 04 to 07. First, the user Y sends the electronic mail 02 to the opposite party, the user Z. The user Z returns to the user Y the electronic mail 04 as a reply to the electronic mail 02. As explained before, the reply can be created by manipulating the “REPLY” button 30b in the window 30 in FIG. 4. As a result, the user Y receives the electronic mail 04. Subsequently, the user Y returns to the user Z the electronic mail 05 as a reply to the electronic mail 04. Thereafter, the user Y also returns to the user Z the electronic mail 06 as an additional reply to the electronic mail 04. When the user Z receives the electronic mails 05 and 06, the user Z returns to the user Y the electronic mail 07 as a reply to the electronic mail 06. It is possible to consider a reply to an electronic mail to be subordinate to the electronic mail. The tree structure of FIG. 8 is produced based on this consideration.

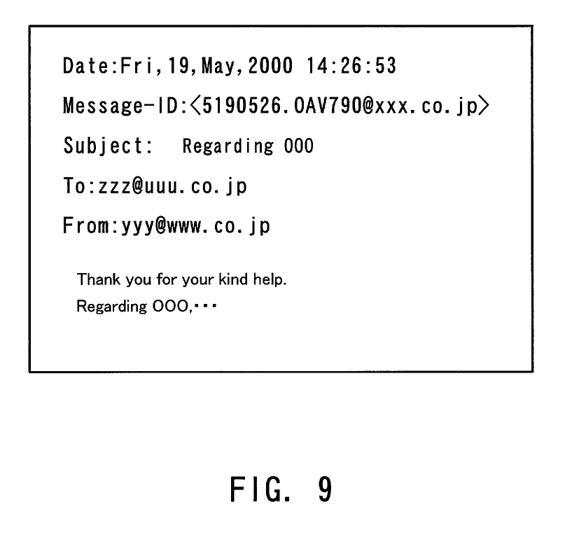

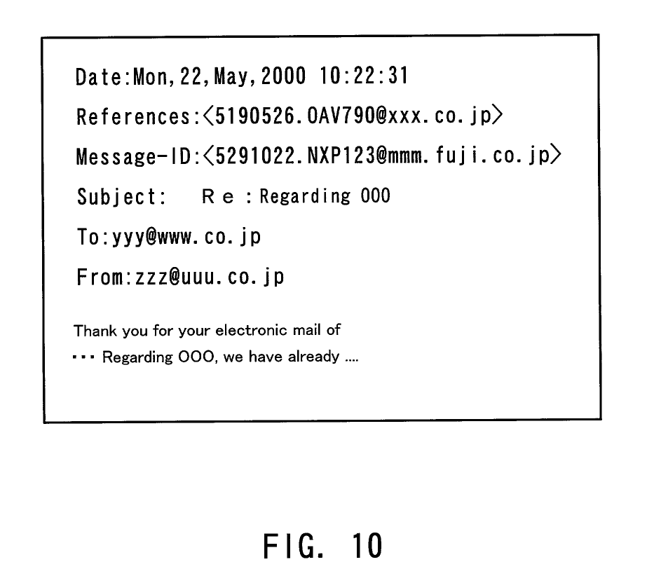

In addition, generally, a reply to an electronic mail contains, in the header of the reply, information which specifies the electronic mail. For example, the electronic mail 02 transmitted from the user Y to the user Z contains in its header and text the information as illustrated in FIG. 9, where the header contains the dates of transmission, a message ID (identification number), the title (subject), the receiver (destination), and the sender. When the user Z receives the electronic mail 02 of FIG. 9, and returns a reply (the electronic mail 04) to the electronic mail 02, the user Y receives the electronic mail 04 as illustrated in FIG. 10. In the example of FIG. 10, the electronic mail 04 contains the message ID of the electronic mail 02 as a reference. Thus, the user Y can identify the original electronic mail based on the reference.

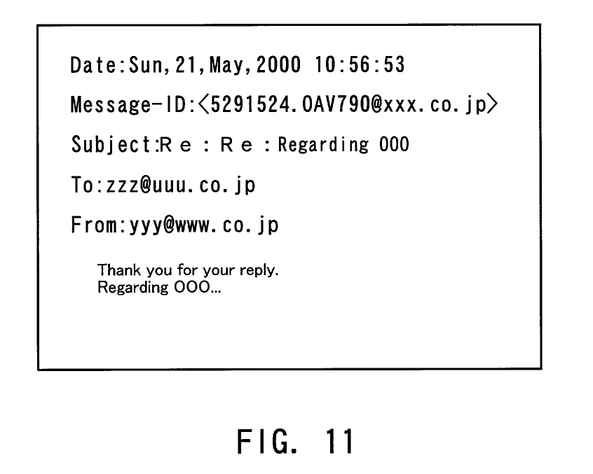

Thereafter, when the user Y returns a reply (the electronic mail 05) to the electronic mail 04, the contents of the electronic mail 05 as illustrated in FIG. 11 are stored in the transmitted-electronic-mail box of the user Y. As illustrated in FIG. 11, the contents of the electronic mail 05 stored in the transmitted-electronic-mail box of the user Y do not contain the reference to the message ID of the original electronic mail. In the conventional electronic-mail transmission/reception apparatuses, the subordination of an electronic mail to another electronic mail is recognized based on the reference to the message-ID of the original electronic mail. Therefore, in the above case, the conventional electronic-mail transmission/reception apparatuses cannot recognize the relationship between the electronic mails 04 and 05. However, according to the present invention, a tree indicating a relationship between electronic mails satisfying a specified condition is produced, for example, based on character strings of the titles of the electronic mails, and displayed. Thus, it is possible to recognize a relationship between a reply and an original electronic mail, from the displayed tree.

### (6) Example of Sorting Operation

First, it is assumed that the setting items 40a and 40c are selected in the first display-setting window 40 illustrated in FIG. 5, i.e., sorting of all of the electronic mails regardless of their dates or serial numbers is requested. It is further assumed that the setting item 60b is selected in the second display-setting window 60 so that electronic mails having a nearly identical title (subject) are sorted into a group forming a tree.

After the above setting of the sorting conditions, the CPU 20a first refers to the information input into the first display-setting window 40 of FIG. 5, and selects electronic mails to be sorted, from among all of the electronic mails which have been transmitted or received up to that time.

Next, the CPU 20a refers to the information input into the second display-setting window 60 of FIG. 6, and divides the electronic mails to be sorted, into groups. Since, in this example, the setting item 60b is selected in the second display-setting window 60, and the titles of the electronic mails 02, 04 to 07 are identical except for the character string “Re:”, the electronic mails 02, 04 to 07 are sorted into the same group.

Subsequently, the CPU 20a executes processing for hierarchizing electronic mails in each group, i.e., producing a tree of the electronic mails in each group. In the group of the electronic mails 02, 04 to 07, the electronic mail 02 is determined to be a parent electronic mail (i.e., an electronic mail in the top layer of the hierarchy) for the following reasons:

(1) The electronic mail 02 is first transmitted (or received).

(2) The title (subject) of the electronic mail 02 does not include the character string “Re:”, which indicates subordination to another electronic mail.

(3) The electronic mail 02 does not contain the reference ID.

Subsequently, the electronic mail 04 is determined to be a child electronic mail which is subordinate to the electronic mail 02 for the following reasons:

(1) The title (subject) of the electronic mail 04 includes the character string “Re:”, which indicates subordination to another electronic mail.

(2) The electronic mail 04 contains as a reference the message ID of the electronic mail 02.

Next, the electronic mail 05 is determined to be a child electronic mail which is subordinate to the electronic mail 04 for the reason that the title (subject) of the electronic mail 05 indicates that the electronic mail 05 is a reply to the electronic mail 04 having the title “Re: Regarding OOO”. Similarly, the electronic mail 06 is determined to be a child electronic mail which is subordinate to the electronic mail 04.

Finally, the electronic mail 07 is determined to be a child electronic mail which is subordinate to the electronic mail 06 for the reason that electronic mail 07 contains as a reference the message ID of the electronic mail 06.

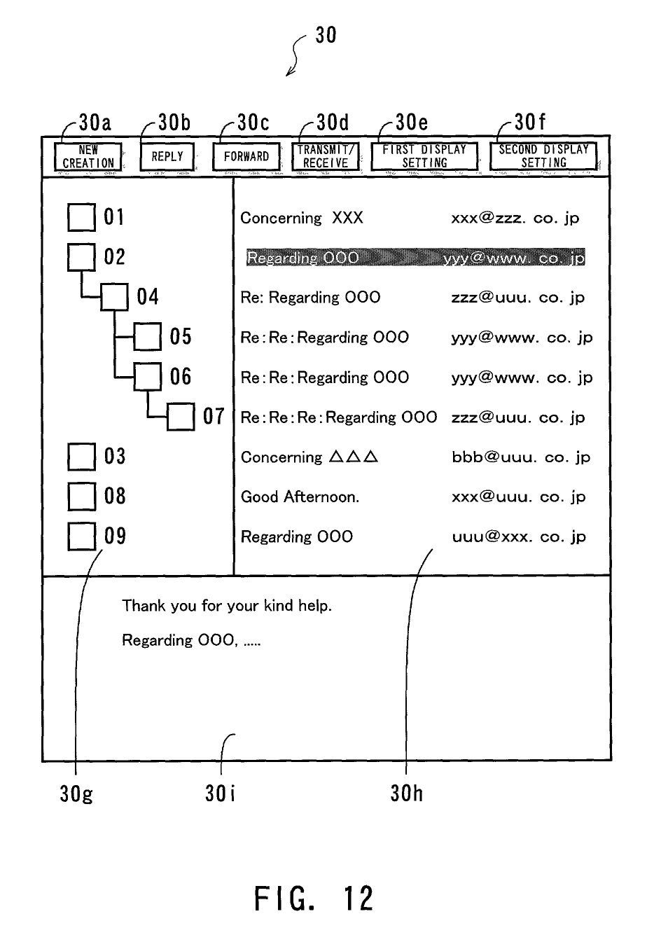

Thus, the hierarchical structure (tree) of the electronic mails 02, 04 to 07 is determined. Similar processing is performed for each of the other group or groups so that a tree is produced for each group. When a tree for each group is produced, the CPU 20a updates the contents of the display areas 30g and 30h according to the results of the processing, for example, as illustrated in FIG. 12. In the example of FIG. 12, the tree structure of the electronic mails 02, 04 to 07 is displayed. In addition, each of the electronic mails 03, 08, 09 is displayed separately.

As explained above, electronic mails are sorted into groups based on the attribute information such as the reference IDs and titles (subjects), and a tree of each group is produced and displayed. Thus, electronic mails can be displayed in the form which can be easily recognized by users.

Although, in the above embodiment, both the transmitted electronic mails and the received electronic mails are displayed together in the same display areas in the window 30, it is possible to display the transmitted electronic mails and the received electronic mails in the separate display areas. Further, it is possible to display the transmitted electronic mails and the received electronic mails differently by using icons or the like.

### (7) Variations of Sorting Operations

In the above example, the setting item 60b is selected in the second display-setting window 60 so that electronic mails having a nearly identical title (subject) are sorted into a group forming a tree. When another setting item is selected in the second display-setting window 60, the electronic mails can also be sorted into groups, and a tree of each group is produced and displayed, by performing similar processing to the above case where the setting item 60b is selected.

For example, when the setting item 60c is selected in the second display-setting window 60, and the character string “malfunction” is input into the text box in the setting item 60c, electronic mails which includes the character string “malfunction” in its title are sorted into a group, and a tree can be produced and displayed. That is, in this case, the electronic mails which are exchanged for a complaint or complaints about malfunction of a commodity or commodities are sorted into a group, and displayed together with a tree.

When one of the setting items 60d to 60f is selected in the second display-setting window 60, the electronic mails can be sorted into groups based on the character strings of the destination (receiver) information in the electronic mails. For example, when the setting item 60e is selected in the second display-setting window 60, and a character string of a specific domain name is input into the text box in the setting item 60e, electronic mails which includes the specific domain name are sorted into groups, and a tree can be produced and displayed. For example, it is possible to sort only electronic mails exchanged with employees of a specific company, and display the sorted electronic mails in the form of a tree. Alternatively, when the setting item 60f is selected in the second display-setting window 60, for example, it is possible to sort electronic mails other than the electronic mails exchanged with employees of a specific company, and display the sorted electronic mails in the form of a tree.

When one of the setting items 60g to 60i is selected in the second display-setting window 60, the electronic mails can be sorted based on character strings of the sender information in the electronic mails, in a similar manner to the above case where one of the setting items 60d to 60f is selected.

When one of the setting items 60j to 60l is selected in the second display-setting window 60, the electronic mails can be sorted into groups based on character strings in the predetermined information item (indicated as “XXXX” in FIG. 6) included in the headers of the electronic mails, where the predetermined information item is preset separately. For example, when the predetermined information item is preset as information on servers through which each of the electronic mails is transmitted to the electronic-mail transmission/reception apparatus, it is possible to exclude the electronic mails which are transmitted through a specific server from the electronic mails to be sorted. Such exclusion is useful, for example, when a risk of virus infection is high in the electronic mails transmitted through the specific server.

When one of the setting items 60m to 60o is selected in the second display-setting window 60, the electronic mails can be sorted into groups based on specific information included in the headers of the electronic mails. The specific information indicates, for example, the priority or sender of the electronic mail, or the mailing list through which the electronic mail is transmitted or received. When the setting item 60m is selected, electronic mails having an identical priority are sorted into a group forming a tree. When the setting item 60n is selected, electronic mails transmitted from each sender are sorted into a group forming a tree. When the setting item 60o is selected, electronic mails corresponding to each mailing list are sorted into a group forming a tree.

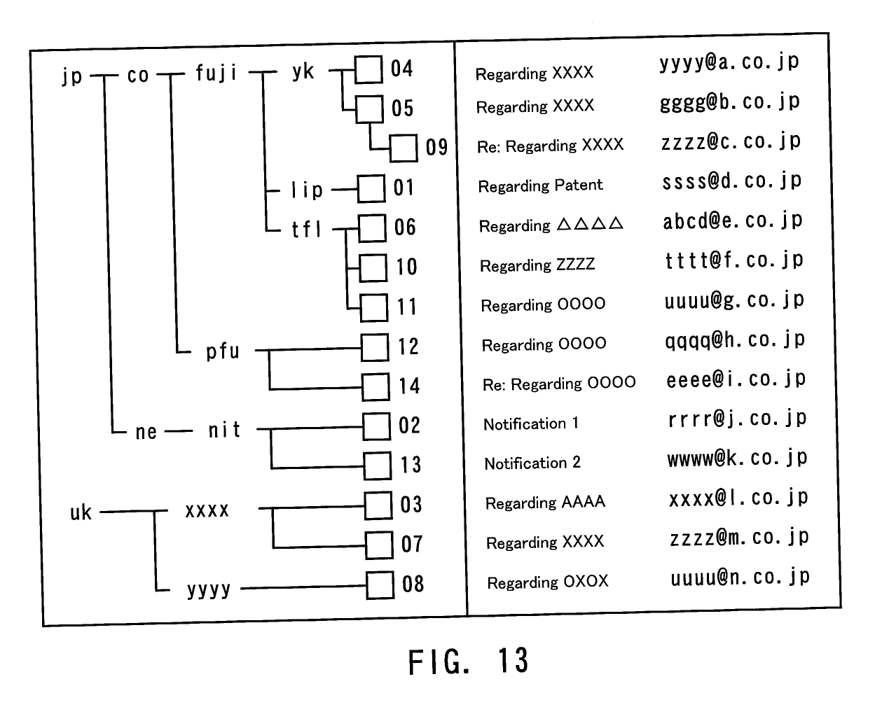

FIG. 13 shows an example of a display of trees and information on electronic mails which are grouped according to the sender information. In FIG. 13, the display area 30i is not shown. In this example, the mail addresses of the senders are decomposed into elements, and displayed as a tree-like list. According to this method, it is possible to easily find a target electronic mail or mails by using the domain name as a key. For example, when the domain name of the target electronic mail contains “pfu.co.jp”, it is possible to immediately recognize that the electronic mails corresponding to the serial numbers 12 and 14 are the target electronic mails.

When the setting item 60p is selected, and a specific character string is input into a text box in the setting item 60p, electronic mails which include the specific character string in their texts are sorted into a group forming a tree.

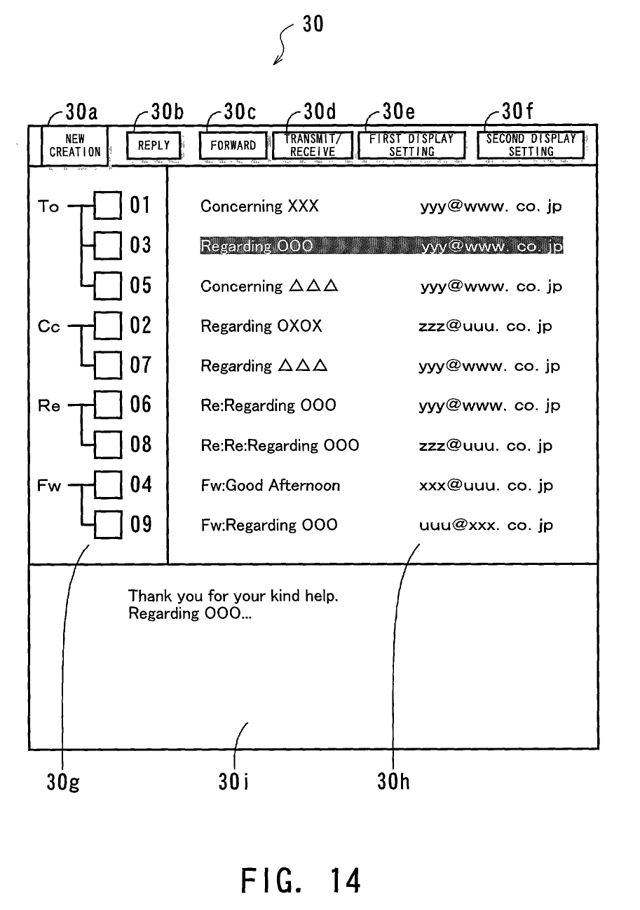

Further, the electronic mails which are directly transmitted to its destination (indicated with “To” in FIG. 14), transmitted as a copy (indicated with “Cc” in FIG. 14), returned as a reply (indicated with “Re” in FIG. 14), and forwarded (indicated with “Fw” in FIG. 14) can be displayed separately, for example, as illustrated in FIG. 14. In FIG. 14, the electronic mails directly transmitted to its destination are indicated with “To”, the electronic mails transmitted as a copy are indicated with “Cc”, the electronic mails returned as a reply are indicated with “Re”, and the forwarded electronic mails are indicated with “Fw”. Generally, the electronic mails directly transmitted to its destination can be considered to be more important than the other electronic mails. Therefore, when the electronic mails are grouped according to types of electronic mails as above, the importance of each electronic mail can be reflected in the display, and resultantly viewability can be increased.

### (8) Operation Sequence

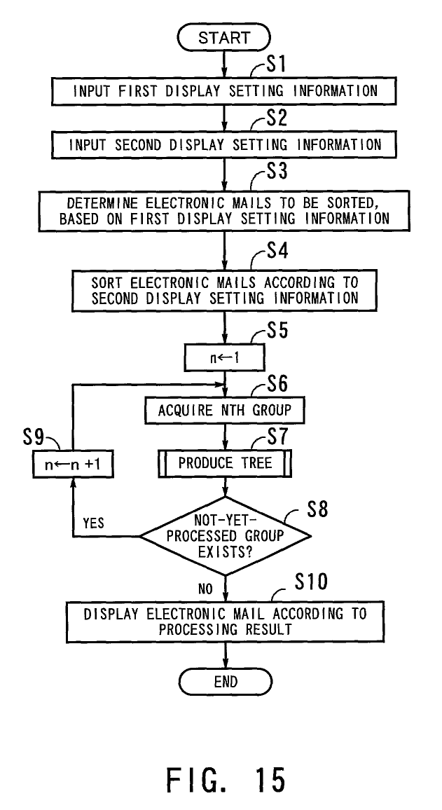

FIG. 15 is a flow diagram illustrating an example of a sequence of operations performed in the electronic-mail transmission/reception apparatus as an embodiment of the present invention.

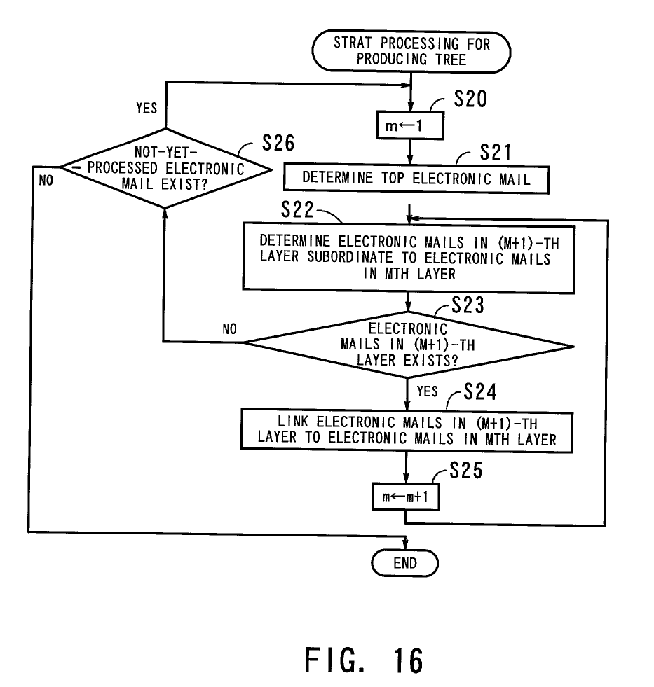

In step S1, the CPU 20a displays the first display-setting window 40 as illustrated in FIG. 5 on the display device 20h, and receives information input into the first display-setting window 40. In step S2, the CPU 20a displays the second display-setting window 60 as illustrated in FIG. 6 on the display device 20h, and receives information input into the second display-setting window 60. In step S3, according to the information input into the first display-setting window 40, the CPU 20a determines a target electronic mail or mails (i.e., an electronic mail or mails to be sorted) from among the electronic mails stored in the HDD 20d. In step S4, according to the information input into the second display-setting window 60, the CPU 20a sorts the target electronic mail or mails into a group or groups. In step S5, the CPU 20a sets a variable n to one, where the variable n indicates the number of group or groups of the target electronic mail or mails which have already been processed at that time. In step S6, the CPU 20a acquires the nth group. In step S7, the CPU 20a executes processing for producing a tree (hierarchical structure) for the nth group. Details of this processing are explained later with reference to FIG. 16. In step S8, the CPU 20a determines whether or not a group of the target electronic mail or mails which have not yet been processed exists. When yes determined in step S8, the operation goes to step S9. When no determined in step S8, the operation goes to step S10. In step S9, the CPU 20a increments the variable n by one. In step S10, the CPU 20a displays the processed electronic mails in the display areas 30g and 30h in accordance with the hierarchical structure.

Thus, in accordance with the flow of FIG. 15, the target electronic mail or mails can be sorted into a group or groups in accordance with the information input into the first and second display-setting windows, and the electronic mails in each group can be displayed in the form of a tree.

FIG. 16 is a flow diagram illustrating an example of a sequence of operations of producing a tree in step S7 of FIG. 15.

In step S20, the CPU 20a sets a variable m to one, where the variable m indicates the number of layer or layers in each tree (hierarchical structure) which have already been processed at that time. In step S21, the CPU 20a determines an electronic mail in the top layer of the hierarchical structure, i.e., an electronic mail at the top of the tree. As a general rule, an electronic mail which is sent at an earliest time is determined to be the electronic mail in the top layer. However, when the setting item 40b is selected in the first display-setting window 40, the electronic mail specified in the setting item 40b (i.e., the electronic mail corresponding to the serial number input into the text box in the setting item 40b) is determined to be the electronic mail in the top layer. In step S22, the CPU 20a determines an electronic mail or mails in the (m+1)-th layer based on the electronic mail or mails in the mth layer. In step S23, the CPU 20a determines whether or not an electronic mail or mails exits in the (m+1)-th layer. In step S24, the CPU 20a links the electronic mail or mails in the (m+1)-th layer to the electronic mail or mails in the mth layer. That is, in order to produce a hierarchical structure to be displayed as a tree, each electronic mail in the (m+1)-th layer is linked to one of the electronic mail or mails in the mth layer. In step S25, the CPU 20a increments the variable m by one. In step S26, the CPU 20a determines whether or not an electronic mail or mails in the group which have not yet been processed exists. When yes determined in step S26, the operation goes to step S20. When no determined in step S20, the operation of FIG. 16 is completed.

Thus, a tree of each group (i.e., a hierarchical structure of an electronic mail or mails in each group) can be produced.

### (9) Restricted Display

The above electronic-mail transmission/reception apparatus may be realized by a personal computer having the hardware construction of FIG. 3. Alternatively, the electronic-mail transmission/reception apparatus according to the present invention can be realized in a portable terminal such as a mobile telephone. In the latter case, the number of characters which can be displayed on a screen is limited, and viewability of the display is increased by, for example, the following provision.

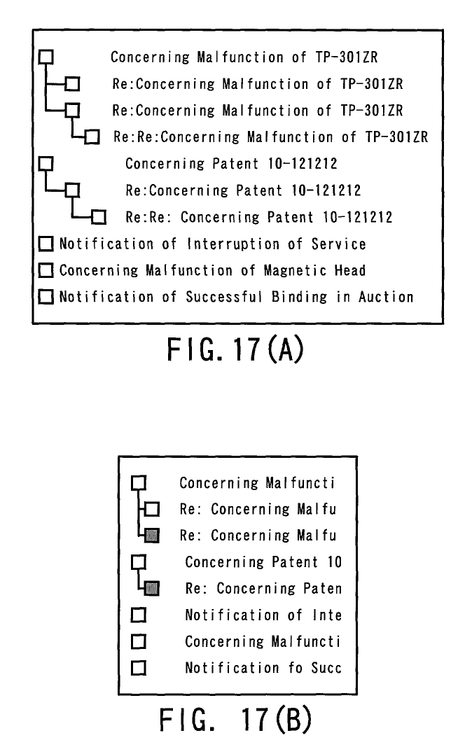

The displayed depth of the tree (hierarchical structure) is restricted as well as the number of characters. For example, when trees and information on electronic mails which are to be displayed are as illustrated in FIG. 17(A), the number of the characters of each title (subject) is restricted to twenty, and the depth of the tree (hierarchical structure) is restricted to two. According to these restrictions, the trees and information illustrated in FIG. 17(A) are displayed on a screen as illustrated in FIG. 17(B). Due to the above restrictions, only portions of the trees and information illustrated in FIG. 17(A) are displayed in FIG. 17(B). In the example of FIG. 17(B), the filled squares each indicate that at least one electronic mail which is subordinate to the electronic mail corresponding to the filled square exists. It is possible to design the electronic-mail transmission/reception apparatus so as to display the electronic mail which is subordinate to the electronic mail corresponding to the filled square, for example, when a user moves a cursor on the filled square, and performs a predetermined manipulation.

According to the above provision, it is possible to prevent the decrease in viewability even when the number of characters which can be displayed on a screen is limited.

### (10) Other Matters

(i) The functions of the electronic-mail transmission/reception apparatus according to the present invention can be realized by a computer. The functions of the electronic-mail transmission/reception apparatus can be written as a program, which can be stored in a computer-readable storage medium. The functions can be realized by a computer by executing the program. The computer-readable storage medium may be a magnetic storage device, a semiconductor memory, or the like. In order to put the program into the market, the program may be stored in a portable storage medium such as a CD-ROM (compact-disk read-only memory) and a floppy disc. Alternatively, the programs can be stored in a storage device belonging to a first computer, and transferred to a second computer connected through a network to the first computer. When the program is executed by a computer, the program can be stored in a hard disk drive or the like belonging to the computer, and loaded into a main memory of the computer.

(ii) The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

(iii) All of the contents of the Japanese patent application, No. 2000-267360 are incorporated into this specification by reference.

What is claimed is:

1. An electronic-mail transmission/reception apparatus for transmitting and receiving electronic mails, comprising:
a condition setting unit which sets in said electronic-mail transmission/reception apparatus a condition for displaying a list of at least one information item on at least one title of at least one electronic mail which has been transmitted or received;
a sorting unit which sorts said at least one information item into a hierarchical structure according to said condition; and
a list displaying unit which displays a list of said at least one information item which is sorted by said sorting unit.

2. An electronic-mail transmission/reception apparatus according to claim 1, wherein said sorting unit sorts said at least one information item according to attribute information which each of said at least one electronic mail has.

3. An electronic-mail transmission/reception apparatus according to claim 2, wherein said at tribute information is contained in a header of said at least one electronic mail.

4. An electronic-mail transmission/reception apparatus according to claim 1, further comprising a display information removing unit which removes a portion of information displayed by said list displaying unit, according to display capacity of said list displaying unit.

5. A computer-readable storage medium storing a program which makes a computer execute processing for transmitting and receiving electronic mails, said program further makes said computer realize:
a condition setting unit which sets in said computer a condition for displaying a list of at least one information item on at least one title of at least one electronic mail which has been transmitted or received;
a sorting unit which sorts said at least one information item into a hierarchical structure according to said condition; and
a list displaying unit which displays a list of said at least one information item which is sorted by said sorting unit.
